(19) United States
(12) Patent Application Publication
(10) Pub. No.: US 2018/0041396 A1
(43) Pub. Date: Feb. 8, 2018

(54) SYSTEM AND METHOD FOR TOPOLOGY DISCOVERY IN DATA CENTER NETWORKS

(71) Applicant: Futurewei Technologies, Inc., Plano, TX (US)

(72) Inventors: Zhenjiang Li, San Jose, CA (US); Serhat Nazim Avci, Milpitas, CA (US); Fangping Liu, San Jose, CA (US)

(73) Assignee: Futurewei Technologies, Inc., Plano, TX (US)

(21) Appl. No.: 15/229,029

(22) Filed: Aug. 4, 2016

(51) Int. Cl. H04L 12/24; H04L 12/755; H04L 12/733

(52) U.S. Cl. CPC H04L 41/12; H04L 45/20; H04L 45/021

(57) ABSTRACT

The disclosure relates to technology for discovering a topology in a network. The discovery procedure includes providing a representation for the topology of the network and transmitting a probe message to a probed network node. The representation identifies neighboring nodes of the probed network node. In response to receiving a returned message corresponding to the probed message from the network, it is determined whether the probe message was returned from a newly discovered neighboring node of the probed network node. In response to determining that the returned message corresponding to the probe message was returned by the newly discovered neighboring node, the representation of the topology is updated to identify the newly discovered neighboring node of the probed network node. The probe message is then transmitted to the newly discovered neighboring node.

### BACKGROUND

Data centers store business information and provide global access to the information and application software through a plurality of computer resources. Data centers may also include automated systems to monitor server activity, network traffic and performance. A typical data center houses computer resources such as mainframe computers, web, application, file and printer servers executing various operating systems and application software, storage subsystems and network infrastructure. A data center may be either a centralized data center or a distributed data center interconnected by either a public or private network.

A centralized data center provides a single data center where the computer resources are located. Since there is only one location, there is a saving in terms of the number of computer resources required to provide services to the user and management of the computer resources is much easier, while capital and operating costs are reduced. A distributed data center is one that locates computer resources at geographically diverse data centers. The use of multiple data centers provides critical redundancy, albeit at higher capital and operating costs.

### BRIEF SUMMARY

In one embodiment, there is a method for discovering a topology in a network, comprising providing a representation for the topology of the network; transmitting a probe message to a probed network node, the representation to identify neighboring nodes of the probed network node; in response to receiving a returned message corresponding to the probed message from the network, determining whether the probe message was returned from a newly discovered neighboring node of the probed network node; and in response to determining that the returned message corresponding to the probe message was returned by the newly discovered neighboring node, updating the representation of the topology to identify the newly discovered neighboring node of the probed network node, and transmitting the probe message to the newly discovered neighboring node.

In another embodiment, there is a controller for discovering a topology in a network, comprising a memory storage comprising instructions; and one or more processors coupled to the memory that execute the instructions to: provide a representation for the topology of the network; transmit a probe message to a probed network node, the representation to identify neighboring nodes of the probed network node; in response to receiving a returned message corresponding to the probed message from the network, determine whether the probe message was returned from a newly discovered neighboring node of the probed network node; in response to determining that the returned message corresponding to the probe message was returned by the newly discovered neighboring node, update the representation of the topology to identify the newly discovered neighboring node of the probed network node, and transmit the probe message to the newly discovered neighboring node.

In still another embodiment, there is a non-transitory computer-readable medium storing computer instructions for discovering a topology in a network, that when executed by one or more processors, causes the one or more processors to perform the steps of providing a representation for the topology of the network; transmitting a probe message to a probed network node, the representation to identify neighboring nodes of the probed network node; in response to receiving a returned message corresponding to the probed message from the network, determining whether the probe message was returned from a newly discovered neighboring node of the probed network node; in response to determining that the returned message corresponding to the probe message was returned by the newly discovered neighboring node, updating the representation of the topology to identify the newly discovered neighboring node of the probed network node, and transmitting the probe message to the newly discovered neighboring node.

In yet another embodiment, there is a method for discovering a topology in a network according to any one of claims 2-9, wherein the probe message and the withdraw message are BGP update messages.

In another embodiment there is a method for discovering a topology in a network according to any one of claims 2-9, further comprising exchanging the probe message between the probed network node and the neighboring nodes based on defined network policies; and parsing the route update message returned from the neighboring nodes of the probed network node to perform at least one of creating and removing nodes associated with the representation of the topology.

In still another embodiment there is a method for discovering a topology in a network according to any one of claims 2-9, wherein the route update message is a BGP route withdraw message to indicate failure of one of (a) a link between any one of the probed network node and the neighboring nodes and (b) the probed network node and the neighboring nodes.

In still another embodiment there is a method for discovering a topology in a network according to any one of claims 2-8, further comprising in response to receiving a route update message as the returned message, determining whether the route update message is a withdraw message; and updating the representation of the topology to remove a next-hop node of any node returning the returned message in response to the route update message being a withdraw message.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 illustrates an example network having a data center in which embodiments of the technology may be implemented.

FIGS. 2A and 2B illustrate discovery of neighboring nodes in a network topology in accordance with the disclosed technology.

FIG. 3 illustrates a block diagram of system components in accordance with the disclosed technology.

FIG. 4A illustrates a network discovery implemented in accordance with the system and networks disclosed in FIGS. 1-3.

FIG. 4B illustrates a flow diagram in accordance with the network discovery implementation depicted in FIG. 4A.

FIGS. 5A and 5B illustrate a topology discovery with a reduced number of probe messages.

FIGS. 6A-6D are additional flow diagrams of the network discovery process illustrated in FIG. 4B.

FIG. 7 illustrates a large scale data center network with a distributed deployment of controllers in accordance with the disclosed technology.

FIG. 8 illustrates a block diagram of a network system that can be used to implement various embodiments.

### DETAILED DESCRIPTION

The disclosure relates to technology for discovering a topology in a network, such as a data center network (DCN). In particular, the technology probes network nodes, such as switches or routers, to discover neighboring nodes in the network based on defined policies. The policies may be, for example, border gateway protocol (BGP) policies derived by the controller based on system configurations. The discovered nodes may be traversed with a modified breadth first search (BFS) algorithm to discover the network topology.

More specifically, the controller provides a representation for the topology of the network and transmits a probe message to a probed network node. The representation identifies neighboring nodes of the probed network node. In response to receiving a returned message corresponding to the probed message from the network, it is determined whether the probe message was returned from a newly discovered neighboring node of the probed network node. In response to determining that the returned message corresponding to the probe message was returned by the newly discovered neighboring node, the representation of the topology is updated to identify the newly discovered neighboring node of the probed network node. The probe message is then transmitted to the newly discovered neighboring node. Notably, the topology is discoverable without having to deploy a protocol other than BGP (although other protocols are not prohibited from being deployed).

It is understood that the present embodiments of the invention may be implemented in many different forms and that claims scopes should not be construed as being limited to the embodiments set forth herein. Rather, these embodiments are provided so that this disclosure will be thorough and complete and will fully convey the inventive embodiment concepts to those skilled in the art. Indeed, the invention is intended to cover alternatives, modifications and equivalents of these embodiments, which are included within the scope and spirit of the invention as defined by the appended claims. Furthermore, in the following detailed description of the present embodiments of the invention, numerous specific details are set forth in order to provide a thorough understanding. However, it will be clear to those of ordinary skill in the art that the present embodiments of the invention may be practiced without such specific details.

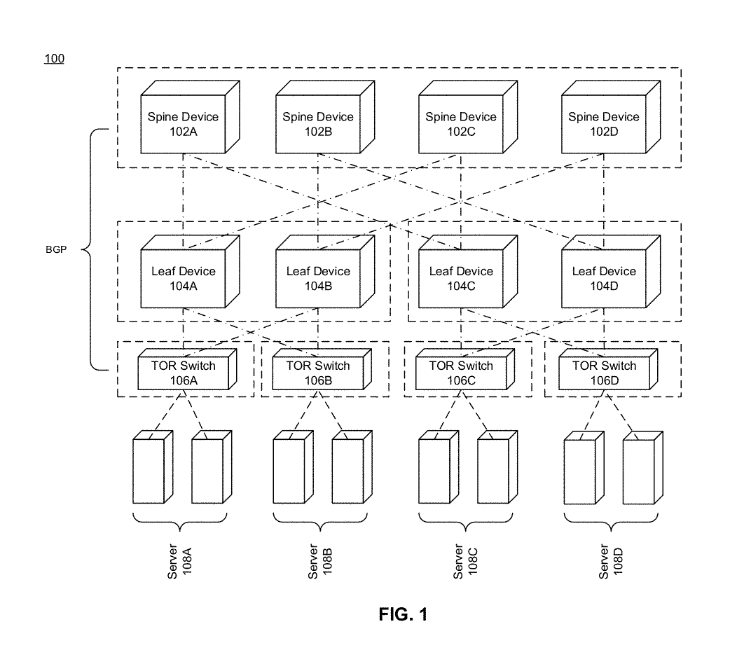

FIG. 1 illustrates an example network having a data center in which embodiments of the technology may be implemented. In general, data center network 100 provides an operating environment for applications and services for customers (not shown) coupled to the data center network 100, for example, by a service provider network (not shown). Data centers, e.g., data center network 100, may include a number of server farms including various servers, such as web servers, application servers, file servers, email servers, print servers, database servers, etc. A server farm may include multiple servers, such as servers 108A, 108B, 108C and 108D, facilitating one or more common and/or different functions.

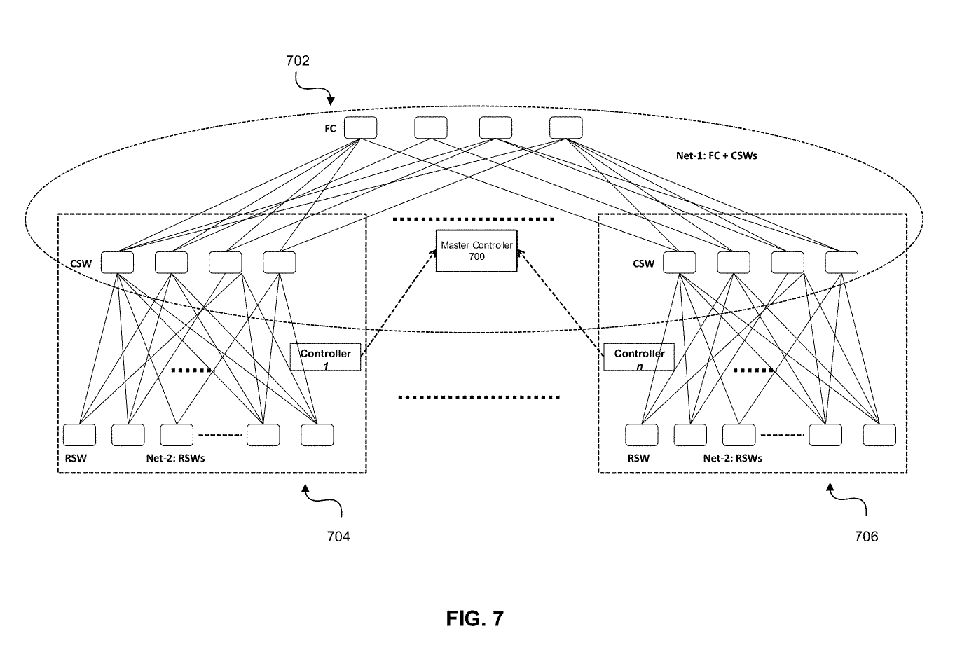

It is appreciated that the network depicted in FIG. 1 of a data center network is non-limiting and that any form of communication system or network may be employed. In one embodiment, data center network 100 may represent one or more geographically distributed network data centers, for example, as depicted in FIG. 7 described below. For example, there may be more or fewer servers, TOR switches, leaf devices and/or spine devices. For example, an embodiment of data center network 100 may include 10,000 servers coupled to appropriate numbers of TOR switches, leaf devices and spine devices.

The data center network 100 as depicted in FIG. 1 includes, for example, a spine devices, such as spine devices 102A, 102B, 102C and 102D, communicatively coupled to a plurality of leaf devices, such as leaf devices 104A, 104B, 104C and 104D, which are communicatively coupled to top-of-rack (TOR) switches, such as TOR switches 106A, 106B, 106C and 106D. The TOR switches 106A, 106B, 106C and 106D are communicatively coupled to one or more servers 108A, 108B, 108C and 108D, respectively.

In the example embodiment, each TOR switch 106A-106D is coupled to two of leaf devices 104A-104D. For example, TOR switch 106A is communicatively coupled to leaf devices 104A and 104B. Additionally, each of the leaf devices 104A-104D is communicatively coupled to two of spine devices 102A-102D.

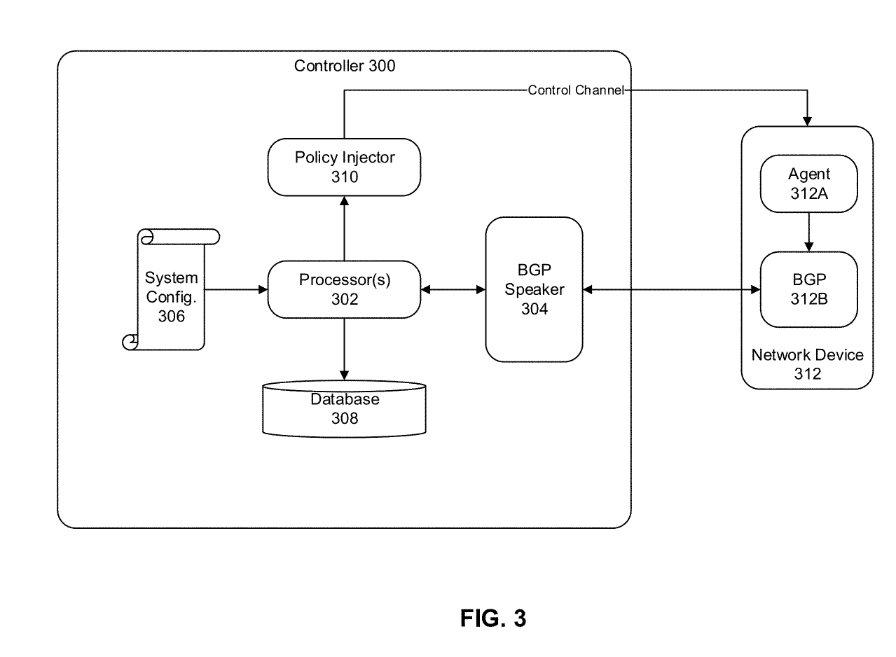

As appreciated, spine devices 102A-102D may be routers or switches and comprise the core of the data center network 100. Spine switches can operate using Layer 3 (L3) to allow for scalability and may connect with a network control system (not shown), such as controller 300 (FIG. 3), that operates as the central network engine or software defined network (SDN) controller. The leaf devices 104A-104D are responsible for aggregating traffic from server devices 108A-108D and connect to core of the data center network 100, comprising the spine devices 102A-102D.

Each server 108A-108D typically will include an operating system that provides executable program instructions for the general administration and operation of that server, and typically will include a computer-readable medium or storage device storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

Certain components of data center network 100 may be an autonomous system (AS) or routing domain within, for example, an entity or organization. An AS is a group of network devices, such as routers or switches, running a common protocol, such as the border gateway protocol (BGP) and operating under the single entity or organization. For example, in FIG. 1, spine devices 102A-102D comprise a first AS, leaf devices 104A-104D comprise a second AS, and TOR switches 106A-106D comprise a third AS. Links between these ASes, such as links between spine devices 102A-102D, leaf devices 104A-104D, and TOR switches 106A-106D, represented by dotted lines, may be configured to run the BGP for routing on those links.

BGP allows an AS to apply diverse local policies for selecting routes and propagating reachability information to other domains. The routers within a routing domain typically communicate routes via internal (i.e., within a domain) routers and routing protocols. Internal routers executing routing protocols are used to interconnect nodes of the various routing domains. An example of a routing protocol is the aforementioned BGP, which performs routing between ASes by exchanging routing and reachability information among routers of the systems. Routers configured to execute the BGP protocol, called BGP routers or speakers maintain routing tables, transmit routing update messages, and render routing decisions based on routing metrics and policies.

The routing table for each BGP router (or speaker) in one embodiment lists all feasible paths to or within a particular network. BGP routers, residing both in and outside the ASes, exchange routing information under certain circumstances. For example, if a pair of routers has established a BGP connection, then they are said to be peers to each other. BGP peer connections go through a negotiating session in which connecting peers exchange OPEN messages, containing router ID, AS numbers etc. If negotiations are successful, then the peer connection is said to be established.

Routers will send route UPDATE messages, which will either advertise new prefixes (e.g., IP address to define reachability of the network) or withdraw previously advertised prefixes. When new or withdrawn prefixes are received, updates to the routing table are performed. For example, when a BGP router initially connects to a peer router, they may exchange the entire contents of their routing tables. Thereafter, when changes occur, the routers exchange only those portions of their routing tables that change in order to update their peers' tables. The BGP routing protocol is well-known and described in further detail in “Request For Comments (RFC) 4271,” by Y. Rekhter et al. (2006), incorporated by reference.

As appreciated, and with reference to FIG. 9 (described below in detail), the routers may include a processor, such as CPU 910, coupled to a memory, such as 920, and a plurality of network interface adapters, such as 950, via a bus, such as 970. Network interfaces 950 may be coupled to other BGP speakers. Memory 920 may comprise storage locations, such as 930, addressable by the processor 910 and interface adapters 950 for storing software programs and data structures, as is well-known in the art. For example, memory may store data structures such as a peer table and a routing table.

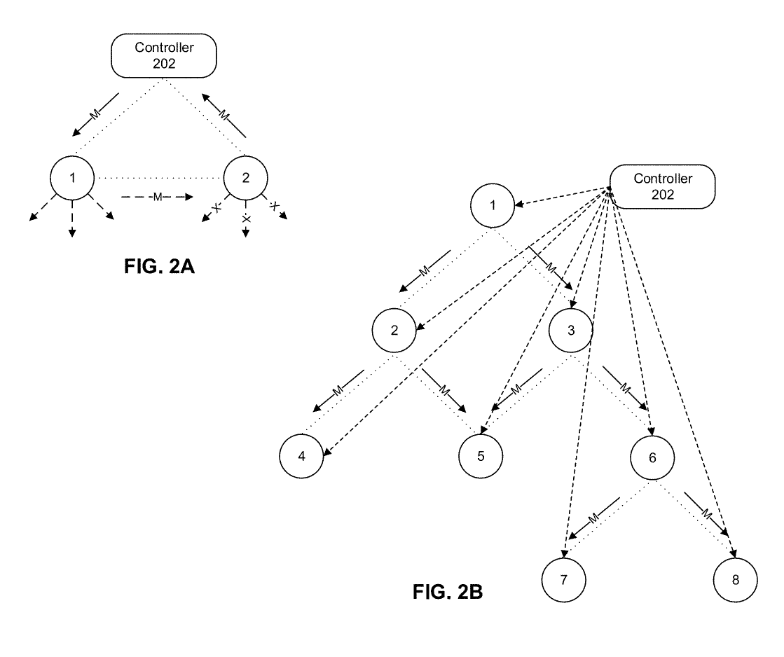

FIGS. 2A and 2B illustrate discovery of neighboring nodes in a network topology in accordance with the disclosed technology. A network can include any number of devices (or nodes), for example the routers and switches discussed above with reference to FIG. 1, that are in wireless or wired communication. Each node can be within range of one or more other nodes and can communicate with the other nodes or through utilization of the other nodes, such as in a next-hop or multi-hop topography (e.g., communications can hop from node to another node until reaching a final destination).

In the depicted example, controller 202 (discussed in below with reference to FIG. 3) generates and issues probe messages M to a selected node, such as node 1 or node 2.

In the example of FIGS. 2A and 2B, the controller 202 employs a one router hop methodology by employing the BGP policies. In this case, controller 202 may issue a probe message M to node 1, which in turn will relay the probe message M to each of its neighboring (i.e., one hop) nodes. In the example of FIG. 2A, node 2 is a one hop neighbor of node 1. Dashed arrow lines represent paths to other neighboring nodes for which the probe message M may be transmitted (dashed arrow lines with an “x” represent paths to neighboring nodes (of node 2) that are disqualified from transmitting the probe M since they are not one hop neighbors to node 1).

In one embodiment, the probe message M is a BGP route UPDATE message. UPDATE messages are used to transfer routing information between BGP peers (or neighbors), as explained above. The information in the UPDATE message may be used to construct a graph, such as the graphs in FIGS. 2A and 2B, that describes the relationships of the various ASes. An UPDATE message may also be used to advertise feasible routes that share common path attributes to a peer, or to withdraw multiple unfeasible routes from service. In this context, various ingress and egress policies (described below) may be defined to filter routes such that the probe message M may be relayed or blocked along a particular path or from a particular node.

Continuing with the example of FIG. 2A, if a controller wants to determine all adjacent links/neighboring nodes of node 1, the probe message M is sent by the controller 202. More specifically, the controller 202 initiates discovery of the neighboring nodes of node 1 (in this case, the probed network node) by sending a probe message M to node 1.

Upon receipt of the probe message M at node 1, the probe message M is relayed by node 1 and to each of its neighbors (represented by the dashed arrow lines). After receiving the probe message M at node 2, the probe message M is returned to controller 202. However, in this case, the probe message M is not sent to node 2 neighboring nodes based on the pre-defined BGP policies. That is, the policies determine whether a route is to be further relayed to node 1's neighbor and blocked from node 2's neighbor but return to the controller. As noted, these policies may be based on special values carried by the probe message, for example community values. At this stage, controller 202 recognizes that node 2 is a neighbor of node 1 and can update or modify the network topology accordingly.

In one embodiment, the probe message M is tagged using a special value for BGP to relay or block probe messages M. This tag enables the controller 202 to identify or recognize when the probe message M is being returned from a particular node. For example, tagging allows an operator to associate state information with a route, which can be used to coordinate decisions made by a group of routers in an AS, or to share context across AS boundaries.

In FIG. 2B, the network topology illustrated has eight nodes (nodes 1-8). A probe messages M is initially sent by controller 202 to one of nodes 1-8, as represented by the dashed arrow lines. As noted above, the controller 202 may randomly select one of nodes 1-8 to send the probe message M, or may select a particular node to send the probe message M based on a predefined location or based on known system configurations available to controller 202.

Further to the example of FIG. 2A, the probe message M in FIG. 2B may be pushed from the controller 202 one step or level further by probing each of the node 1 neighbors that have returned the probe message M (similar to node 2 returning probe message M). Thus, as each one of the nodes 1-8 receives the probe message, the corresponding neighbor nodes will be discovered by virtue of the probe message M being returned to the controller 202. Topology discovery will end once each of the nodes 1-8 in the network have been probed. In one embodiment, the controller 202 may also validate a reverse adjacent link or neighbor (for example, validate the path from node 2 to node 1 as a neighbor node).

FIG. 3 illustrates a block diagram of system components in accordance with the disclosed technology. The system components include, but are not limited to, topology discovery (TD) controller 300 and network device (node) 312.

TD controller 300 may be, for example controller 202 in FIG. 2, and include, but is not limited to, processor(s) 302, BGP speaker 304, system configurations 306, database 308 and policy injector 310. It is appreciated that any one or more of the components may be separately located from the TD controller 300 or be a part of the TD controller 300 (as shown).

TD controller 300 defines policies to be used by BGP on the network device(s) 312 based on configurations as detailed in the system configurations 306. The TD controller 300 is also responsible for implementing the discovery procedure as described herein, as well as updating and modifying the database 308.

The BGP speaker 304, in addition to performing BGP peering as described above, is also responsible for sending probe messages M in BGP UPDATE, messages in accordance with the processor(s) 302 request, and receives return probe messages M which are passed along to the processor(s) 302.

System configurations 306 generally include neighbor information for use with BGP peering. For example, network device 312 information for BGP peering, such as IP, AS#, etc. may be stored as part of the system configuration 306. Other examples of system configuration information include, but are not limited to, roles of the network devices 312 for reducing the number of probe messages to send from the TD controller 300, as detailed below.

Policies are rules that include condition(s) and action(s) to be performed upon a match of such conditions. Use of such policies allows for a consistent and efficient control and coordination of configuration parameters that are common to different network devices 312. These policies may be configured in the system configuration 306 for implementation by applying network commands at a respective network device 312, such as a switch or router. In one embodiment, the network policies are used to not only manage and configure network elements associated with traffic flow, but to also manage other aspects of the network such as to define dependencies between software levels and hardware revision levels on the network and control other aspects of the network infrastructure.

The BGP, however, cannot interpret or understand the policies derived from the TD controller 300. Thus, policy injector (or translator) 310 translates the policies defined by the TD controller 300 (and stored in system configuration 306) into a comprehensible BGP configuration. For example, the policy injector 310 receives the policy information derived from the TD controller 300 and normalizes the configuration statements into a BGP policy. This policy may then be stored in memory or a database (not shown). These configurations may then be communicated from the TD controller 300 (and policy injector 310) to the network devices 312 via a control channel, such as NETCONF.

Topology database (dB) 308 stores topological information about the network environment. Topological information may be in the form of objects which represent topological nodes, views, viewnodes, and types. The information may represent a logical or physical topology of the network. The topology database 308 may also be updated to reflect updates and changes made in the network.

Network device 312 includes, but is not limited to, an agent 312A and BGP 312B. Agent 312A receives BGP configurations as translated by the policy injector 310 via the control channel. Once received, the agent 312A interprets and applies the BGP configurations at the network device 312.

BGP 312B may be embodied as a single process executing on a single processor, e.g., a central processing unit (CPU), of the network device 312 (e.g., BGP router), or as multiple instances of the BGP process running on a single or multiple CPUs. BGP implementations store and process probe message (e.g., BGP route UPDATE messages) received from respective peer routers, and create and process BGP route UPDATE messages for transmission (advertisement) to those peers. Additionally, the BGP may interpret policies to relay or block received BGP route UPDATE messages based on configurations derived by the processor 302 and translated by policy injector 310.

BGP 312B may also establish connections between autonomous systems (ASes), such as AS 102A-102D and AS 104A-104D, to exchange routing information, as well to distribute received routes within internal BGP peers in the same AS. When a BGP peer is shut down or a link is removed between BGP peers (internally or externally), the BGP peer withdraws the distributed routes (or links) from each of the other external and/or internal BGP peers (i.e., the withdraw routes in the BGP route UPDATE message will propagate though the network and to the TD controller 300.

The route withdrawal may be generated by devices (nodes) in the network, when the device observes an adjacent links is down. This information will be propagated back to and received by the BGP speaker 304 within TD controller 300. As explained, these withdrawals may reach the TD controller 300 to modify and update the topology database 308. (It is also appreciated that routes and links may be automatically added back into the topology if the route/link is up again).

Although a single network device 312 is illustrated in the disclosed embodiment, it is appreciated that any number of network devices 312 may be employed in the network.

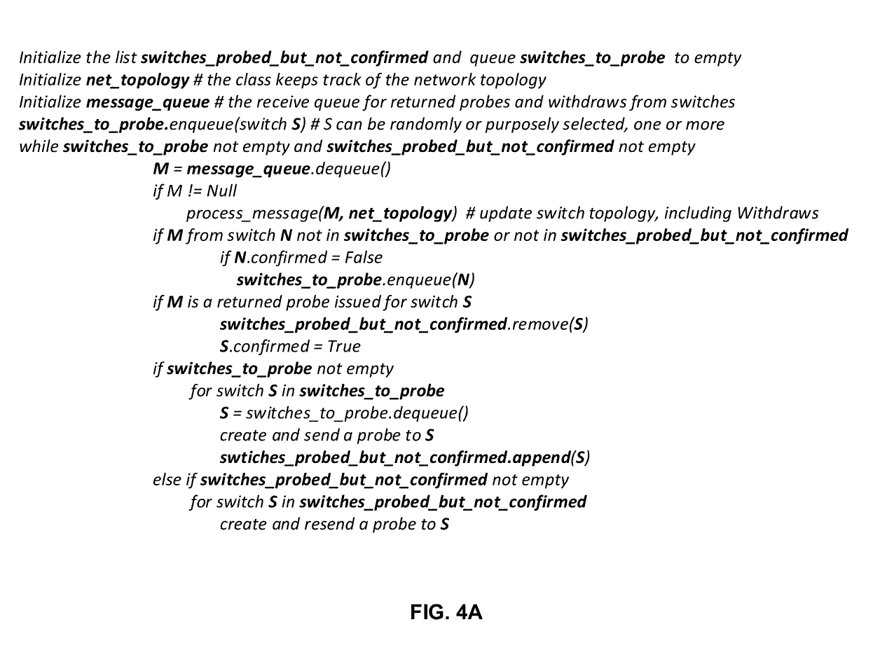

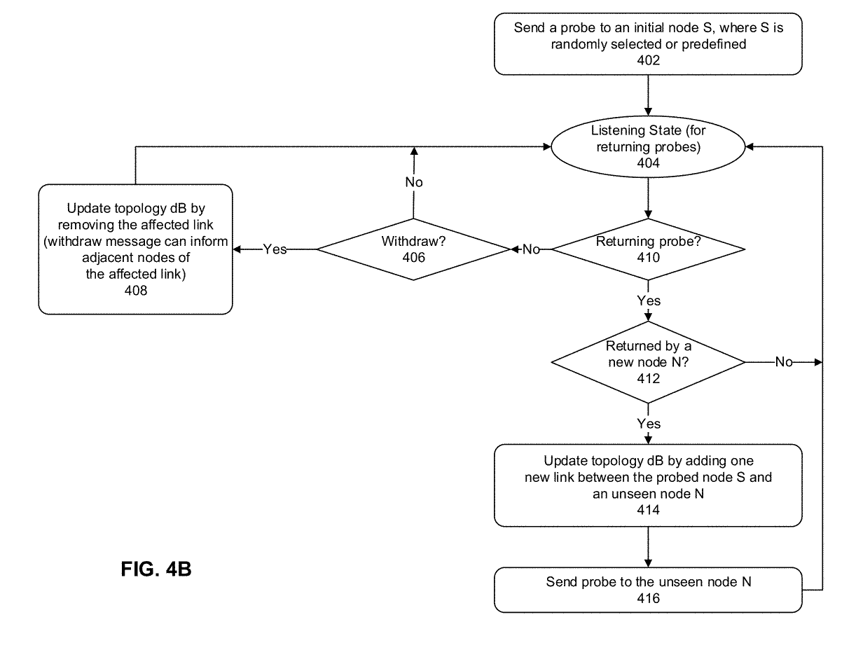

FIG. 4A illustrates a network discovery implemented in accordance with the system and networks disclosed in FIGS. 1-3. FIG. 4B illustrates a flow diagram in accordance with the network discovery implementation depicted in FIG. 4A. For purposes of discussion, the network discovery (i.e., pseudocode) and methodology in the flow diagram of FIGS. 4A and 4B are implemented by TD controller 300. However, it is appreciated that the implementation is not limited to the TD controller 300, and that any processor(s) may employ the pseudocode and methodology. For example, a processor residing on a network device (illustrated or otherwise) may implement the pseudocode and methodology described herein.

The pseudocode depicted in FIG. 4A will be discussed with reference to the flow diagram in FIG. 4B. In general, the methodology is a modified version of the Breadth First Search (BFS) algorithm that utilizes BGP route UPDATE messages fed back from the various network nodes (routers and switches) as a result of the topology discovery phase. The BFS algorithm (as discussed herein, the BFS algorithm refers to the modified or enhanced and distributed BFS according to the disclosed technology) traverses or searches a tree or graph data structure, such as those illustrated in FIGS. 2A and 2B.

In one embodiment, BFS begins at the tree root or a randomly selected node of a graph and explores neighbor nodes first, before moving to the next level neighbors. In another embodiment, BFS begins at a node or set of nodes selected based on a deployed topology to reduce the number of probes to send from the TD controller 300. In this case, the system configurations 306 and policies derived from the TD controller 300 are defined sufficiently to enable the BFS to automatically select and begin at a specified node or set of nodes.

In order to discover the topology of a network, such as network 100 depicted in FIG. 1, the TD controller 300 maintains (1) a list of nodes (e.g., switches or routers) that have been probed but not confirmed (i.e., sent a probe message from the TD controller but have not received a corresponding returned probe message), (2) a queue of nodes to be sent probe message (nodes to be probed) and (3) a list of probe messages M returned by the nodes. It is appreciated that these lists may be maintained individually, as a single list or any combination of lists.

The lists may be stored in memory or any database communicatively coupled to the TD controller 300, and are updated as the BFS traverses the tree or graph data structures. As explained earlier, topology database 308 tracks and stores the network topology as the tree or graph data structure is traversed, and according to the information stored and updated in the various lists.

At 402, the TD controller 300 sends an initial node S (the probed node) a probe message M, where S is a randomly selected or predefined node (predefined in this context may also mean selected based on system configurations and policies derived by the TD controller). The TD controller 404 remains in a listening state at 404 to listen for returned probe messages M or withdraw messages propagated from nodes within the network.

If a probe message M is not returned to the TD controller 300 at 410, then the TD controller 300 determines whether a withdraw route UPDATE message has been received at 406. If no withdraw route UPDATE message has been received by the TD controller 300 at 406, then the TD controller 300 continues in the listening state at 404.

If the TD controller 300 identifies a withdraw route UPDATE message received from a node in the network at 406, then the TD controller 300 updates the topology database 308 by removing the a link between the probed node and neighbor node at 408, and proceeds back to the listening state at 404. It is appreciated that the lists noted above may also be updated and modified to reflect the changes. Thus, the TD controller 300 utilizes the BGP route update message to identify the topology of the network (in this case, to remove a link or node) without having to employ additional protocols.

In the event that the TD controller 300 determines that a probe message M has been returned at 410, the TD controller 300 then determines whether the probe message was returned by an existing (or known) node or a newly discovered (unseen) node N at 412. As explained above, the TD controller 300 may, for example, identify the probe message M and node with a tag that was attached to the probe message M. If the probe message M was returned from a known node (i.e., a node that TD controller 300 already has in one of the lists and/or topology), then the process returns to 404 in the listening state

If the TD controller 300 determines that the returned probe message M is from a newly discovered node N at 412, then the topology database 308 is updated to reflect a new link (neighbor node) between the probed node S and the newly discovered (unseen) node N at 414, and a probe message M is transmitted to the newly discovered node N for further discovery (i.e., to discover neighboring nodes) at 416. The process returns to 404 until each of the nodes in the network have been discovered. Thus, the TD controller 300 utilizes the BGP route update message to identify the topology of the network (in this case, to add a new link or node) without having to employ additional protocols.

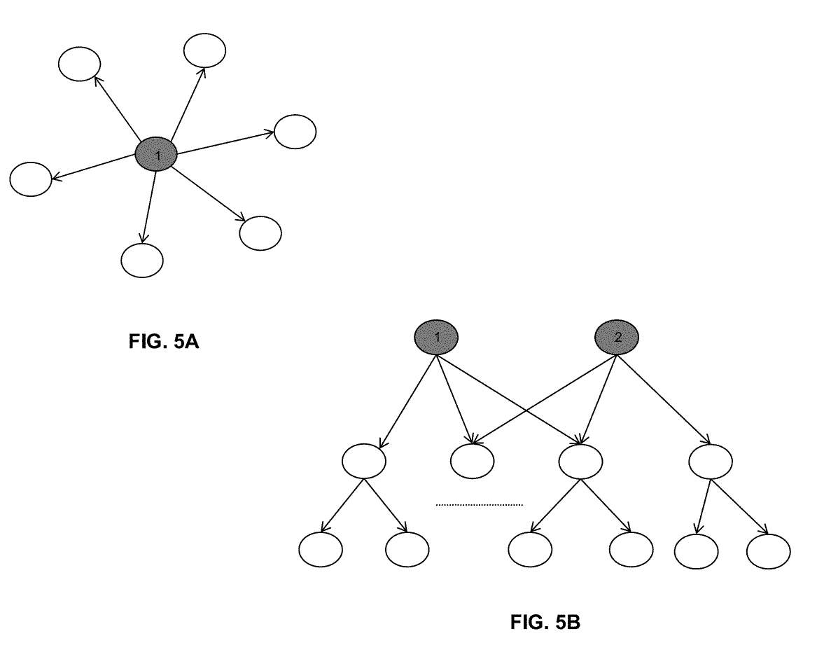

FIGS. 5A and 5B illustrate a topology discovery with a reduced number of probe messages. FIG. 5A illustrates a star network topology, and FIG. 5B illustrates a fat tree network topology. In the examples of FIGS. 5A and 5B, we consider the processor(s) 302 has been provided with sufficient system configurations 306 to define policies based on various roles of network devices 312 within each of the networks.

In one example embodiment, with the system configurations 306 of the star network, the processor(s) 302 can determine that probing the central (or hub) node 1 will result in speeding up discovery of the entire topology and result in a fewer number of probe messages M needing to be transmitted from the TD controller 300 in order to traverse the entire topology of the star network (FIG. 5A).

In another example embodiment, with the system configurations 306 of the fat tree network, the processor(s) 302 can determine that probing the top (highest) level node 1 and node 2 first will result in speeding up the discovery of the entire topology and result in a fewer number of probe messages M needing to be transmitted from the TD controller 300 in order to traverse the entire topology of the fat tree network (FIG. 5B).

As explained above, if the processor(s) 302 has insufficient system configurations 306, an initial node for probing may be randomly selected or predefined. It is also appreciated that the networks disclosed in FIGS. 5A and 5B are non-limiting examples, and that the system configurations 306 may be defined to include any network configuration.

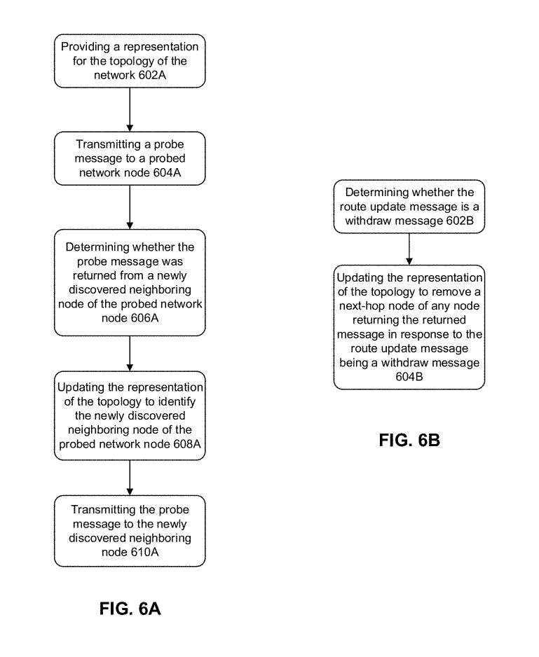

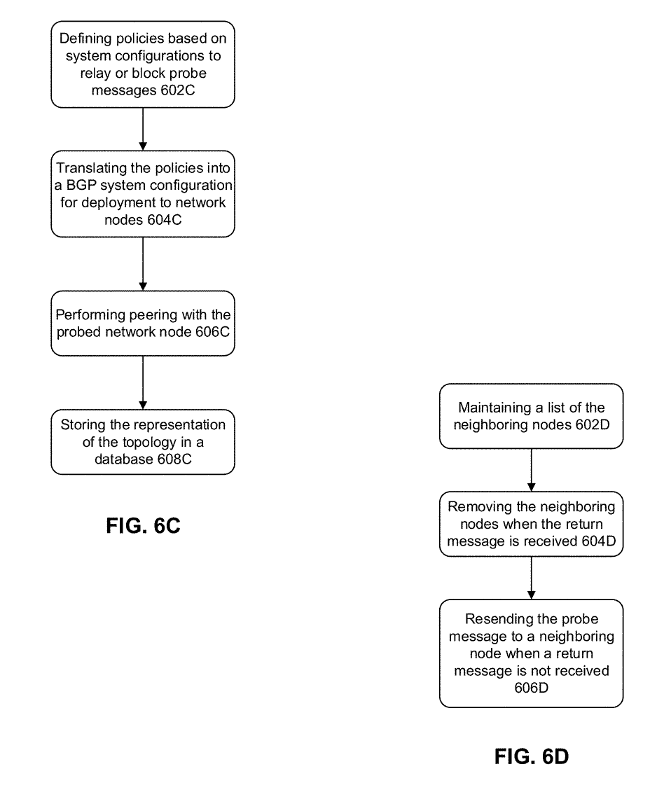

FIG. 6A-DB are additional flow diagrams of the network discovery process illustrated in FIG. 4B. The process described with reference to FIGS. 6A-6D are implemented by the TD controller 300, although it is appreciated that any processor or component in the system may be used for implementation.

Referring to FIG. 6A, the TD controller 300 provides a representation for the topology of the network at 602A. The representation may be, for example, a list of nodes in the network maintained and stored in database 308 or a graphical structure, such as a tree structure depicted in FIGS. 2A, 2B, 5A and 5B. However, the representation of the network topology is not limited to these example embodiments.

At 604A, the TD controller 300 transmits a probe message to a probed network node, where the representation of the topology identifies neighboring nodes of the probed network node. In response to receiving a returned message corresponding to the probed message from the network, the TD controller 300 determines whether the probe message was returned from a newly discovered neighboring node of the probed network node at 606A.

If the TD controller 300 determines that the returned message corresponding to the probe message was returned by the newly discovered neighboring node, the representation of the topology is updated in the database 308 to identify the newly discovered neighboring node of the probed network node at 608A, and the TD controller 300 transmits the probe message to the newly discovered neighboring node at 610A.

Turning to FIG. 6B, in response to the TD controller 300 receiving a route update message as the returned message, it is determined whether the route update message is a withdraw message at 602B. The representation of the topology is updated to remove a next-hop node of any node returning the returned message in response to the route update message being a withdraw message at 604B.

With reference to FIG. 6C, the TD controller 300 defines policies for deployment on the probed network node and neighboring nodes based on system configurations at 602C. In one embodiment, the policies define mechanisms to relay and block the probe messages M at the probed network node and the neighboring network nodes.

Since BGP does not understand policies derived by the TD controller 300, the policies are translated into BGP system configurations for deployment to the probed network node and the network nodes by policy injector 310 at 604C.

The BGP speaker 304 may perform peering with the probed network node based on system configurations at 606C, and the topology may be stored in the database 308 at 608C. It is appreciated that peering between the TD controller 300 and each node in the network can begin once the peering information has been received from the system configurations 306.

With reference to FIG. 6D, in order to monitor discovery of the network nodes, a list of nodes to which the TD processor 300 has sent a probe message M may be maintained by the TD controller 300 at 602D.

At 604D, a node S is removed from the aforementioned list when a probe message M, issued by TD processor(s) 300 for node S and returned from any neighboring node (returning node) of node S, is received at the TD processor(s) 300.

At 606D, the TD controller 300 resends the probe message M to each node for which the probe message M has been transmitted but a return message has failed to be received.

FIG. 7 illustrates a large scale data center network with a distributed deployment of controllers in accordance with the disclosed technology. The scalable data center network (DCN) includes, for example, data center networks 702, 704 and 706. As depicted, data center network 702 comprises core switches and cluster switches (CSW) from each of data center networks 704 and 706. The data center network 702 (net-1) is also controlled by master controller 700, such as a TD controller 300. Each of the data center networks 704 and 706 (net-2)) include CSWs and rack switches (RSWs), along with a respective controller 1 and n, such as a TD controller 300.

The scalable DCN is implemented in the disclosed embodiment using a fat-tree structure, in which each of the data center networks 702, 704 and 706 individually represent a node in the fat-tree structure, similar to a node in a tree or graph structure above. That is, the fat-tree structure (topology) is being used as a mechanism to couple a cluster of data center networks, including the various switches and routers within each data center network.

The switches may be implemented as any type of device for switching (e.g., routing) a packet from an input port (ingress) of the switch to an output port (egress) of the switch. In some implementations, the switch is implemented as a device that performs layer 2 switching (e.g., which forwards a packet based on a media access control (MAC) layer address), layer 3 switching (also referred to as layer 3 routing, which forwards a packet based on an Internet Protocol (IP) address as well as other layer 3 information), or a combination of both layer 2 and 3.

The communication links (lines between switches) provide links (or paths) between a source and a destination. For example, a typical implementation of communication links is direct copper or fiber optic links providing bidirectional communications. The communication links may be implemented, however, using other media and using unidirectional (e.g., doubling the ports at each switch), dedicated, and/or shared (e.g., networked) communication links as well. Moreover, communication links may include, alone or in any suitable combination, one or more of the following: fiber optic connections, a local area network (LAN), a wide area network (WAN), a dedicated intranet, a wireless LAN, the Internet, an intranet, a wireless network, a wired network, a bus, or any other communication mechanisms.

Individually, each of the network topologies may be discovered in a manner as discussed above. However, the topology of the scalable data center network (including networks 702, 704 and 706) may also be discovered in a similar manner, where master controller 700 operates in concert with controllers 1 and n to discover the entire topology of all data center networks 702, 704 and 706. In one embodiment, the discovery methodology discussed above is performed in each of data center networks 704 and 706 by controllers 1 and n, respectively. Results of the discovery may be uploaded from each of the controllers 1 and n to the master controller 700, which will aggregate and produce the overall network topology of the DCN. Thus, the methodology described above may be employed to discover the topology of the scalable DCN.

In one example embodiment of deploying a DCN, data center network 702 (Net-1) deploys one TD controller 700, which serves as the master controller. If we assume a maximum port number of each switch is 128, there are 128 face-down ports at the core switches and up to 32 (128/4) ponds (cluster level networks, such as data center networks 704 and 706). Thus, the total number of cluster switches (CSWs) is 128, which can support up to 80 k servers, such as servers 108A-108D.

Data center networks 704 and 706 each represent a pond with 4 CSWs and 48 rack switches (RSWs), with each RSW having 48 face-down and 4 face-up ports. Accordingly, there are approximately 2,500 servers/ponds (48 RSWs×48 ports), where each pond deploys a single TD controller that covers approximately 52 switches (48+4).

Following the example above, the topology discovery time estimate for the above DCN is as follows. Each pond contains 52 switches, such that each BGP peering takes P, each triangle probe (node discovery) takes T, each probe processing takes C. All probes at each level of the network may be sent in parallel, and the maximum levels of probes is determined by the height H of the topology tree, which is 2 for a 5 stages folded Clos network.

The total time is therefore the peering time+probe travel+message processing=α(N)*P+β(H)*T+γ(L)*C, where N is the number of nodes in a pond, L is the number of links in a pond, H is the height of a pond (which is 1). The network overhead is O(L), given at least L links to relay probe messages M.

As shown by experimental results, BGP peering P is 1.95 sec., triangle probe T is 1.05˜2.3 sec., probe processing C<0.01 sec., H is 1, C is negligible given the L is about 200, while α(N) can be significantly cut down by multi-threading.

In the data center network 702 (Net-1), the network contains 132 switches, 4*128=512 links and height H is 1. Therefore, the total probe time estimate should be approximately tens of seconds. In the data center networks 704 and 706 (Net-2) deployment, the total number of switches is 52, the total links of each pond is 4*48˜200. Therefore, the total probe time should be at most tens of seconds.

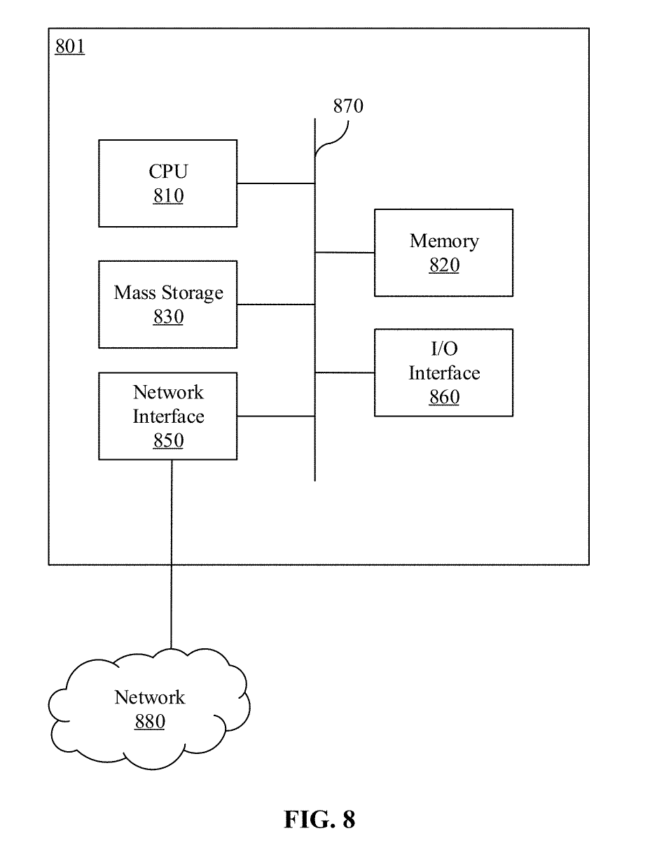

FIG. 8 is a block diagram of a network system that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The network system may comprise a processing unit 801 equipped with one or more input/output devices, such as network interfaces, storage interfaces, and the like. The processing unit 801 may include a central processing unit (CPU) 810, a memory 820, a mass storage device 830, and an I/O interface 860 connected to a bus. The bus may be one or more of any type of several bus architectures including a memory bus or memory controller, a peripheral bus or the like.

The CPU 810 may comprise any type of electronic data processor. The memory 820 may comprise any type of system memory such as static random access memory (SRAM), dynamic random access memory (DRAM), synchronous DRAM (SDRAM), read-only memory (ROM), a combination thereof, or the like. In an embodiment, the memory 820 may include ROM for use at boot-up, and DRAM for program and data storage for use while executing programs. In embodiments, the memory 820 is non-transitory. The mass storage device 830 may comprise any type of storage device configured to store data, programs, and other information and to make the data, programs, and other information accessible via the bus. The mass storage device 830 may comprise, for example, one or more of a solid state drive, hard disk drive, a magnetic disk drive, an optical disk drive, or the like.

The processing unit 801 also includes one or more network interfaces 850, which may comprise wired links, such as an Ethernet cable or the like, and/or wireless links to access nodes or one or more networks 880. The network interface 850 allows the processing unit 801 to communicate with remote units via the networks 880. For example, the network interface 850 may provide wireless communication via one or more transmitters/transmit antennas and one or more receivers/receive antennas. In an embodiment, the processing unit 801 is coupled to a local-area network or a wide-area network for data processing and communications with remote devices, such as other processing units, the Internet, remote storage facilities, or the like.

There are many benefits to using embodiments of the present disclosure. For example, the disclosed technology allows BGP to determine a global view of the network topology, which may result in network healthiness monitoring, congestion detection, failure detection, resource allocation, and traffic engineering.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for discovering a topology in a network, comprising:
providing a representation for the topology of the network;
transmitting a probe message to a probed network node, the representation to identify neighboring nodes of the probed network node;
in response to receiving a returned message corresponding to the probed message from the network, determining whether the probe message was returned from a newly discovered neighboring node of the probed network node;
in response to determining that the returned message corresponding to the probe message was returned by the newly discovered neighboring node,
updating the representation of the topology to identify the newly discovered neighboring node of the probed network node, and
transmitting the probe message to the newly discovered neighboring node.

2. The method of claim 1, further comprising:
defining network policies for deployment on the probed network node and the neighboring nodes based on system configurations, the policies defining at least one of a mechanism to relay and block the probe messages at the probed network node and the neighboring nodes;
translating the network policies into border gateway protocol (BGP) system configurations for deployment to the probed network node and the neighboring nodes;
performing peering with the probed network node based on the system configurations; and
storing the representation of the topology in a database.

3. The method of claim 1, wherein the probe message comprises a tag that represents at least one of (1) information regarding one of the probed network node and the neighboring nodes to probe (2) information to identify the probe message having been injected and (3) information to identify the probe message having been relayed by the probed network node to thereby enable the neighboring nodes in the network to one of forward and block the probe message.

4. The method of claim 1, wherein the probed network node is selected based on the representation of the topology as defined in a system configuration.

5. The method of claim 1, wherein the probed network node and the neighboring nodes are one of a switch and router.

6. The method of claim 1, wherein the network is a data center network (DCN).

7. The method of claim 1, further comprising:
maintaining a list of the probed network nodes to which the probe message has been sent;
removing a corresponding one of the probed network nodes from the list when the returned message corresponding to the probe message is returned from the neighboring nodes; and
resending the probe message to the corresponding one of the probed network nodes for which the probe message has been transmitted and the return message has failed to be received.

8. The method of claim 1, further comprising listening for the returned message after transmitting the probe message.

9. The method of claim 1, further comprising:
in response to receiving a route update message as the returned message, determining whether the route update message is a withdraw message; and
updating the representation of the topology to remove a next-hop node of any node returning the returned message in response to the route update message being a withdraw message.

10. The method of claim 9, wherein the probe message and the withdraw message are BGP update messages.

11. The method of claim 9, further comprising:
exchanging the probe message between the probed network node and the neighboring nodes based on defined network policies; and
parsing the route update message returned from the neighboring nodes of the probed network node to perform at least one of creating and removing nodes associated with the representation of the topology.

12. The method of claim 9, wherein the route update message is a BGP route withdraw message to indicate failure of one of (a) a link between any one of the probed network node and the neighboring nodes and (b) the probed network node and the neighboring nodes.

13. A controller for discovering a topology in a network, comprising:
a memory storage comprising instructions; and
one or more processors coupled to the memory that execute the instructions to:
provide a representation for the topology of the network;
transmit a probe message to a probed network node, the representation to identify neighboring nodes of the probed network node;
in response to receiving a returned message corresponding to the probed message from the network, determine whether the probe message was returned from a newly discovered neighboring node of the probed network node;
in response to determining that the returned message corresponding to the probe message was returned by the newly discovered neighboring node,
update the representation of the topology to identify the newly discovered neighboring node of the probed network node, and
transmit the probe message to the newly discovered neighboring node.

14. The controller of claim 13, wherein the one or more processors coupled to the memory further execute the instructions to:
define network policies for deployment on the probed network node and the neighboring nodes based on system configurations, the policies defining at least one of a mechanism to relay and block the probe messages at the probed network node and the neighboring nodes;
translate the network policies into border gateway protocol (BGP) system configurations for deployment to the probed network node and the neighboring nodes;
perform peering with the probed network node based on the system configurations; and
store the representation of the topology in a database.

15. The controller of claim 13, wherein the probe message comprises a tag that represents at least one of (1) information regarding one of the probed network node and the neighboring nodes to probe (2) information to identify the probe message having been injected and (3) information to identify the probe message having been relayed by the probed network node to thereby enable the neighboring nodes in the network to one of forward and block the probe message.

16. The controller of claim 13, wherein the one or more processors coupled to the memory further execute the instructions to:
maintain a list of the probed network nodes to which the probe message has been sent;
remove a corresponding one of the probed network nodes from the list when the returned message corresponding to the probe message is returned from the neighboring nodes; and
resend the probe message to the corresponding one of the probed network nodes for which the probe message has been transmitted and the return message has failed to be received.

17. The controller of claim 13, wherein the one or more processors coupled to the memory further execute the instructions to:
in response to receiving a route update message as the returned message, determine whether the route update message is a withdraw message; and
updating the representation of the topology to remove a next-hop node of any node returning the returned message in response to the route update message being a withdraw.

18. The controller of claim 17, wherein the probe message and the withdraw message are BGP update messages.

19. The controller of claim 17, wherein the one or more processors coupled to the memory further execute the instructions to:
exchange the probe message between the probed network node and the neighboring nodes based on defined network policies; and
parse the route update message returned from the neighboring nodes of the probed network node to perform at least one of creating and removing nodes associated with the representation of the topology.

20. The controller of claim 17, wherein the route update message is a BGP route withdraw message to indicate failure of one of (a) a link between any one of the probed network node and the neighboring nodes and (b) the probed network node and the neighboring nodes.

21. A non-transitory computer-readable medium storing computer instructions for discovering a topology in a network, that when executed by one or more processors, causes the one or more processors to perform the steps of:
providing a representation for the topology of the network;
transmitting a probe message to a probed network node, the representation to identify neighboring nodes of the probed network node;
in response to receiving a returned message corresponding to the probed message from the network, determining whether the probe message was returned from a newly discovered neighboring node of the probed network node;
in response to determining that the returned message corresponding to the probe message was returned by the newly discovered neighboring node,
updating the representation of the topology to identify the newly discovered neighboring node of the probed network node, and
transmitting the probe message to the newly discovered neighboring node.

22. The non-transitory computer-readable medium of claim 21, wherein the one or more processors perform the additional steps of:
in response to receiving a route update message as the returned message, determining whether the route update message is a withdraw message; and
updating the representation of the topology to remove a next-hop node of any node returning the returned message in response to the route update message being a withdraw message.

23. The non-transitory computer-readable medium of claim 22, wherein the probe message and the withdraw message are BGP update messages.

24. The non-transitory computer-readable medium of claim 22, wherein the one or more processors perform the additional steps of:
exchanging the probe message between the probed network node and the neighboring nodes based on defined network policies; and
parsing the route update message returned from the neighboring nodes of the probed network node to perform at least one of creating and removing nodes associated with the representation of the topology.

25. The non-transitory computer-readable medium of claim 22, wherein the route update message is a BGP route withdraw message to indicate failure of one of (a) a link between any one of the probed network node and the neighboring nodes and (b) the probed network node and the neighboring nodes.
